(19) United States
(12) Patent Application Publication
(10) Pub. No.: US 2009/0125359 A1
(43) Pub. Date: May 14, 2009

(54) INTEGRATING A METHODOLOGY MANAGEMENT SYSTEM WITH PROJECT TASKS IN A PROJECT MANAGEMENT SYSTEM

(76) Inventors: Robert Knapic, Overland Park, KS (US); Kerry Naliwajka, Woodstock, GA (US); Morgan S. Porter, Sparks, NV (US)

Correspondence Address: PERKINS COIE LLP;PATENT-SEA, P.O. BOX 1247, SEATTLE, WA, 98111-1247, US

(21) Appl. No.: 12/170,412

(22) Filed: Jul. 9, 2008

Related U.S. Application Data
(60) Provisional application No. 60/948,648, filed on Jul. 9, 2007.

(51) Int. Cl. G06Q 10/00; G06F 15/16

(52) U.S. Cl. 705/8; 709/204

(57) ABSTRACT

Systems and methods are described for integrating a methodology management system with a project management system (“the system”). In some embodiments, the system can generate a project plan based on a project template. A project template can include a project task, an education component corresponding to the project task, a compliance factor, and a document creation rule. In various embodiments, the system includes a project management template for use with a project management tool; a synchronization engine that synchronizes data of the project management tool with an external data source; and a workflow engine that causes a workflow step to be performed based on a state of the project task.

### CROSS-REFERENCE TO RELATED APPLICATION

This patent application claims the benefit of commonly assigned U.S. Provisional Patent Application Ser. No. 60/948,648, entitled “INTEGRATING A METHODOLOGY MANAGEMENT SYSTEM WITH PROJECT TASKS IN A PROJECT MANAGEMENT SYSTEM,” filed on Jul. 9, 2007, which is incorporated herein in its entirety by reference.

### BACKGROUND

Managing a project generally involves determining tasks for a project, assigning resources to the tasks, scheduling the resources, tracking expenses, reporting progress, and many other activities. Consulting firms and project teams that manage similar projects repeatedly and develop a “best practice” methodology to ensure a consistent, high quality work product. Completing an assigned task in such repetitive projects requires a detailed understanding of how to complete the task, and how the task will be measured for compliance with the company's methodology. Furthermore, assigned tasks sometimes require a document to be produced as the task is worked on or completed.

To facilitate these activities, various project management systems (or “project management tools”) exist, including MICROSOFT PROJECT. Project management systems generally manage scheduling, planning and monitoring of projects. Many of these systems focus on describing, assigning and tracking progress of tasks associated with a project. However, these systems generally do not provide tools to ensure that the best practice methodologies are followed. Moreover, project managers are unable to educate all resources as to how to complete each task of a project using best practices that have developed over time and distilled into a methodology for completing the project, and need to adjust project plans when deadlines are missed or tasks take longer to complete than originally planned.

### BRIEF DESCRIPTION OF THE DRAWINGS

FIGS. 1A-1F are flow diagrams illustrating flows within the system in various embodiments.

FIGS. 2-3 are block diagrams illustrating components of the system in various embodiments.

FIG. 4A is a flow diagram illustrating an embodiment of a consultant using the system's integrated document workbench to generate a deliverable document required for the project task assigned.

FIG. 4B is a flow diagram illustrating an embodiment of an electronic workflow showing approval and electronic delivery of the document generated in 4B.

FIG. 4C is a flow diagram illustrating document reporting.

FIG. 5A is a block diagram illustrating an embodiment of the system.

FIGS. 6A-6B are block diagrams illustrating an embodiment of the architecture of the system's synchronization engine.

FIGS. 6C-6D are flow diagrams illustrating an embodiment of the synchronization of transactions between the project server and applications integrated with the system's Synchronization Engine.

FIGS. 7A-7N are user interface diagrams illustrating various embodiments of user interfaces provided by the system.

### DETAILED DESCRIPTION

The described technology (also referred to herein as “the system”) provides methods and systems for integrating a methodology management system with a project management system so that the project management system is enhanced to deliver methodology compliance instructions, multimedia task training and task work product templates required to complete each project task assigned to a resource. Various embodiments are described, but other embodiments are also possible.

The system includes an automatic synchronization process between the methodology management system and project management system databases using an event driven synchronization engine. The synchronization engine provides a unique method for integrating additional systems with the project management system such as a billing system like the one included with the system. The system delivers compliance instructions, training and document templates that can be used to ensure a high quality, consistent work product for repeated tasks where a methodology is defined. The synchronization engine enables other systems to be added to system to incorporate capabilities provided by the other systems as components of a fully functional “project ecosystem” to perform extremely complex tasks and enforcing methodologies across an enterprise whether it is logistics, manufacturing, IT development, or other aspects of the enterprise's systems.

The methodology knowledge that is delivered can be tightly integrated with the task assignment function of the project management system to provide a single integrated interface for the user. Furthermore, efficiencies are gained because task specific training and best practices are delivered electronically to resources. The system shortens the learning curve for new resources and ensures a detailed understanding of how to complete the task by delivering these task specific materials to the assigned resource as part of the task assignment process.

The system can include integrated project billing configuration, time and expense reporting and commission tracking functions that provide financial managers with greater project control than existing project management systems.

The methodology management system can also include unique best practices, project templates, electronic workflow, multi-media training materials, methodology compliance instructions and work product document templates for implementing supply chain execution systems in a wholesale distribution environment. While the system may be used to develop an electronic methodology for any repetitive project environment, the supply chain execution methodology included represents only one practical use for the system. Other uses are also possible.

The described technology extends currently available project management systems by fully automating and enforcing a complete methodology for a set of projects. By integrating configured methodologies, project planning, task training, a document workbench to generate deliverable documents, standards of performance and compliance measurement for all project tasks, resource planning, electronic workflow, connecting all project stakeholders with a set of role based web project portals and an integrated billing system, the system delivers the most comprehensive set of integrated tools for managing any process requiring a reproducible, measurable project implementation.

The system further extends the functionality available systems by providing an extensible integration architecture which allows third party systems to be added to the current product stack in a seamless manner.

The described technology comprises a web-based methodology management system that enhances the efficiency, compliance and scalability of consulting organizations and project management teams that deliver repetitive projects based on a pre-defined methodology.

A new methodology is created in the system by creating electronic workflow, creating project templates, creating document templates using the system's integrated document workbench, creating training materials and documenting the steps necessary to meet compliance for each project task. Typically an organization will define one or more methodologies as part of system configuration, and make revisions whenever business rules change.

For a new methodology to be created in the system, a flowchart can be developed which documents all business process steps to be followed for the methodology using any standard flowchart tool. The methodology can include all points of communication, decisions and approvals between all project stakeholders.

After the methodology is documented, project tasks can be identified for each type of project to be modeled for the methodology using a word processor, spreadsheet or similar tool. For example, a supply chain consulting company may use one project template for larger projects, another for mid-sized projects and one for small projects. For each task, (a) a methodology compliance instruction document can be created that defines how the task will be measured for compliance, (b) one or more training documents or multimedia videos can be created and (c) deliverable document templates can be created as needed using the integrated document workbench. These materials may be created using a common format such as Adobe PDF, Microsoft Word, or a multimedia file. The materials may be stored in the system's integrated Microsoft SharePoint 2007 document library or other web accessible location.

Once the task methodology materials have been created, one or more project templates can be created for each project type defined above using Microsoft Project 2007. A special base template can be used that includes user defined fields for storing the links to the training materials, methodology compliance instructions and document templates created in the previous step. Tasks can be entered into the project template for each methodology step from the list defined previously. For each task, hyperlinked URL's can be entered that link to the stored location for the corresponding task compliance, training and document templates created in the prior step. The templates can be stored in the project server document library for project templates where they will later be used for project creation.

The integrated workflow capability can be based on Microsoft's Windows Workflow Foundation (WF) and utilizes its integrated features such as e-mail notification. Workflows are typically authored using the SharePoint 2007 Workflow Designer Tool. For each methodology process defined, a workflow can be created. Workflows are typically created for status reports, expense reports, project plans, time sheets, design and implementation documents, milestone signoff documents and invoices, but may be created for any document or task the system supports. Workflows may be used to route tasks and electronic documents through multiple levels of internal approval, but may also include any defined stakeholders including customers or channel partners. The system's custom workflows may route to a named individual or dynamically to a stakeholder with a project specific role such as project manager.

The system utilizes SSL security and can provide a mechanism to protect all methodology documentation from being copied, downloaded, printed or redistributed using an integrated secure Adobe PDF utility.

The system can include an integrated billing system which may be utilized to capture all customer project administrative related data for billing purposes. Alternatively, an external billing system may be integrated into the system by integrating with the system's synchronization engine by creating an additional integration adapter for the application.

A project can be initiated by entering customer and project administrative data into the integrated billing system. This event triggers the synchronization engine to update the integrated project system with customer information. This function may be performed by anyone with appropriate permissions.

A project manager (PM) can then select an appropriate pre-defined project template (MPP) which was created during system setup using Microsoft Project Manager 2007 when the methodology was configured. The selected template can include the desired methodology tasks and links to all training, methodology compliance and task deliverable document templates to be used for the project.

The project manager can customize the project template based on specific requirements for the new project using Microsoft Project Manager 2007.

Once the project is saved and published to the project server, the project methodology engine (PME) can automatically create a portal web site for the end user and electronically routes the project plan to the company's Practice Management (PTCM) for approval, if configured.

The project plan can be further routed and approved by the end user before continuing.

After the end user approves the project plan, the PM searches for available resources (consultants) using the resource availability tools in the project system. Resources are selected and approved as configured by the methodology.

The PM can assign tasks to the selected consultant(s). Consultant(s) are notified of their assignment through electronic workflow which sends a notification e-mail.

After receiving assigned task(s), the consultant can log into the project management system and prepares to complete each task by using the integrated methodology management tools. For each task assigned, a corresponding row may exist under the task support center that includes links to the methodology compliance instructions, training materials and document templates stored in the document workbench.

This feature can be a custom web part created using Microsoft Visual Studio designed for compatibility with the Microsoft SharePoint 2007 platform and Microsoft Project Server 2007. The web part first identifies the logged in user, and the tasks that are currently assigned then determines if the assigned tasks have hyperlink URL's associated with the custom fields created to store task methodology compliance instructions, training materials and document templates. If links are present, the corresponding icons may appear for each task. When the icon is selected, a browser window can be launched that displays the appropriate material for the task. Using this feature, context specific methodology materials are made available to the assigned resource where needed to complete each task without searching or leaving the normal project task display. The methodology web part retrieves data by requesting the appropriate data from the Synchronization Engine UI Web Service. Because the Synchronization Engine UI web service has access to project server data and all other integrated applications, the web interface is capable of providing data stored in the project server or any of the integrated applications such as Billing in a single seamless interface without the user knowing.

In other systems, an assigned task is simply a single line textual explanation of the task which does not explain how to accomplish the work assigned or indicate how the work product will be evaluated for compliance with the methodology.

These features greatly enhance the performance of the assigned resource because they provide context sensitive assistance to guide the consultant in completing the task.

Furthermore, because the content of these features can be maintained in a centralized document server, the latest version of training and methodology compliance materials can always be delivered to the user.

The system can provide a web-based user interface that users can use to access the system's integrated document workbench tool, which assists the consultant in creation of the document. The consultant can be guided by the document workbench to enter all project specific variable values and to select the sections of the template which should be included.

Once selections are entered, the document workbench generates a MS Word 2007 document with all selected parameters for the current project inserted.

The consultant then submits the generated document for electronic approval which can be configured based on business rules. The approved document is stored in the end user portal as a project deliverable and the configured stakeholders are notified.

Other systems are available to create documents based on a template system, but require access to a local area network where document templates are accessible using a UNC path. The system includes an integrated document workbench that supports access to document templates using the internet http protocol, which makes it accessible wherever an internet connection exists. The document workbench supports SSL security to ensure system security while maintaining high accessibility. The document workbench fully utilizes Microsoft Word 2007's underling native XML format to transmit data securely over the internet. See Appendix C for technical documentation.

The consultant completes the tasks, routes the deliverables for approval and generates time and expense sheets for the work performed. The system supports both a time and material billing and milestone billing capability for invoicing projects. The approval steps are configurable based on business rules to support the organization.

Once the time sheet and expenses are approved, the synchronization engine updates the integrated billing system so that invoices can be generated.

An external billing system processes the new timecard and expense report billing data and generates invoices. Invoices may be delivered electronically to the end user portal or sent to the customer via e-mail or printed and mailed.

The user interface can be tightly integrated with the project management server and the enhanced features are presented as additional items within the same screens. This integration provides a simple efficient user experience with the methodology management features adding context sensitive support where needed by the user. Additionally, the system can integrate billing capabilities and other system features through the systems synchronization engine which is an event driven set of services transparent to the user.

System features may be further extended by linking other web based systems to the main system user menu, and synchronizing data through the system's synchronization engine. This architecture provides extensibility of the system to include a wide variety tightly integrated of project related systems. Some examples are shipping systems, transportation management systems, material requirements planning systems, and any other system that is used to coordinate and manage business process decisions in a complex business environment.

The architecture of the system's synchronization engine enables other systems to be tightly integrated with the project server while each system remains naïve to the existence of the others. The synchronization engine web UI and integration services work together to combine data from all integrated systems into a single seamless web user interface.

User data requests made through the web user interface are fulfilled. When a data requests occurs, the synchronization engine's UI web service can make a request to the synchronization web service which determines which system contains the requested data. The synchronization web service can then request the data from the configured system through its integration adapter and returns the data to the UI web service, which can provide the data to the user through a web part. This process occurs automatically without the user's awareness of how the data request was fulfilled.

A billing application and third party systems may be integrated by creating an application adapter that “listens” for synchronization events. When an event occurs, the adapter can submit the transaction to the synchronization engine web service. The synchronization engine may translate the transaction and determines which integrated systems need to be notified based on the configured business rules. The synchronization engine web service may then send the transaction to the appropriate system's integration adapter and waits for confirmation of a successful update. If the update is successful, the log is updated and the transaction can be closed. If unsuccessful, the update is attempted until the configured threshold is reached. If still unsuccessful, the transaction error log can be updated and the system administrator is notified.

This architecture allows the project, billing and other third party systems which are not normally integrated with the project server to communicate seamlessly and share data without knowledge of each other.

The system also can include multilingual information. For example, task descriptions, workflow steps, and training materials may be provided in multiple languages so that geographically dispersed team members can efficiently collaborate on a project. When a resource completes a document after completion of a task, a workflow step may include sending the completed document to a translator for translation into other languages.

Project tasks may include links. For example, a project task may include links to training materials or other information that a resource completing the task may need access to. The links may be provided in a project template that was used to create the project.

Each project task may also have associated compliance information and document generation information. The system can use this information to determine whether a task was successfully completed and to assist the user in generating a document. The document may be for distribution to other team members or customer for whom the project is being completed.

The system may provide a wizard-driven user interface for completion of various activities, such as setting up a project, completing education or documents, checking compliance, completing workflow steps, and so forth.

The system may be used in various environments. For example, when the United States Patent and Trademark Office (USPTO) receives a patent application through its electronic filing system, a supervising Examiner may create a project based on a project template. The project template may indicate workflow steps for examining the application, project tasks, education, compliance, and document generation information. As an example, a task may be to analyze whether the applicant is eligible for the claimed earlier priority date. The supervising Examiner may assign a new Examiner with very little USPTO experience as a resource to complete the task. The system may send an e-mail to the new Examiner indicating the newly assigned application with a link to the project. The project may show tasks that the Examiner can complete but may not show other tasks of the project that the Examiner cannot view (e.g., tasks for the supervising Examiner or the Quality Assurance group). The Examiner can then begin examination of the application. An initial task may be to evaluate priority. A link associated with the task may provide relevant references in the Manual for Patent Examining Procedure (MPEP) and an audiovisual clip from a senior Examiner describing how that senior Examiner completes the task quickly. After reviewing the priority claim and checking the priority documents, the Examiner may indicate that the task is complete. This may result in a workflow step that sends an update electronic mail (“e-mail”) to the supervising Examiner for signing off. The system may then enable a subsequent task enabling the Examiner to review the specification and claims. Again, the system may provide relevant MPEP references and other training materials. As the Examiner works through the Examination, the system may enable the Examiner to generate an Office Action document rapidly. After completing examination, the system may initiate a workflow step to request the supervising Examiner to sign off on the completed Office Action. The system may alert the inventor via email to download the newest Office Action from the electronic filing system. A response to the Office Action from the inventor that is uploaded to the electronic filing system may continue the workflow in the system. Finally, when all examination steps are complete and the claims are allowed, the system may schedule a USPTO printer to print the ribbon copy of the patent and transmit it via United States Postal Service to the inventor. Thus, the system can work with humans and machines to complete project tasks

The system can be used by various government agencies, companies, or any person or entity that manages large projects. The projects can be standard or routine projects as well as emergency projects, such as projects that an emergency aid agency may put into place after a disaster.

In various embodiments, a method is performed by a computing system for integrating a methodology management system with a project management system. The method comprises generating a project plan based on a project template wherein the project template includes a project task, an education component corresponding to the project task, a compliance factor, and a document creation rule; causing the education component to be provided; receiving an indication that the project task was completed; determining whether the compliance factor has been satisfied; and generating a document based on the document creation rule. The project plan can be stored as an XML file. The education component can be provided as a multimedia file. The method may further comprise performing a workflow step corresponding to the project task. The workflow step can include requesting approval that is sent via e-mail. The document can report progress of the project plan (e.g., completion of a project task) or an expense report.

In various embodiments, the system comprises a project management template for use with a project management tool wherein the project management template includes a project task, an education component corresponding to the project task, a compliance factor, and a document creation rule; a synchronization engine that synchronizes data of the project management tool with an external data source; and a workflow engine that causes a workflow step to be performed based on a state of the project task. The workflow step can be performed when a project task is started, delayed, or completed. The system can include one or more machines that perform project tasks (e.g., publishing machines, sawing machines, assembly machines, and so forth). The system may send instructions to such machines as part of the education components. The system may synchronize data from customer relationship management tools, enterprise resource planning (“ERP”) tool, manufacturing resource planning (“MPR”) tools, and so forth. The system can include extended data (e.g., “sidecar data”) that extends data provided by the project management tool. As an example, the sidecar data can indicate to launch an application to complete an aspect of a task, collect information for generating a document, and so forth. The synchronization engine may also synchronize resource availability, such as by checking resource schedules, global address books, and so forth.

In various embodiments, the system includes a computer-readable medium storing computer-executable instructions that, when executed, cause a computing system to perform various methods. As an example, a method can a integrate methodology management system with a project management system by receiving a project template wherein the project template includes a project task, an education component corresponding to the project task, a compliance factor, and a document creation rule; receiving a command to create a project plan based on the project template; generating the project plan based on the template wherein the project plan includes the project task; receiving an indication of a resource to assign to the project task; providing the education component to the indicated resource; receiving a status update from the resource relating to the project task; determining whether the status update satisfies the compliance factor; and generating a document based on the document creation rule.

Several embodiments of the facility are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the importance system. In addition, the data structures and message structures may be stored or transmitted via a data transmission medium, such as a signal on a communications link. Various communications links may be used, such as the Internet, a local area network, a wide area network, or a point-to-point dial-up connection.

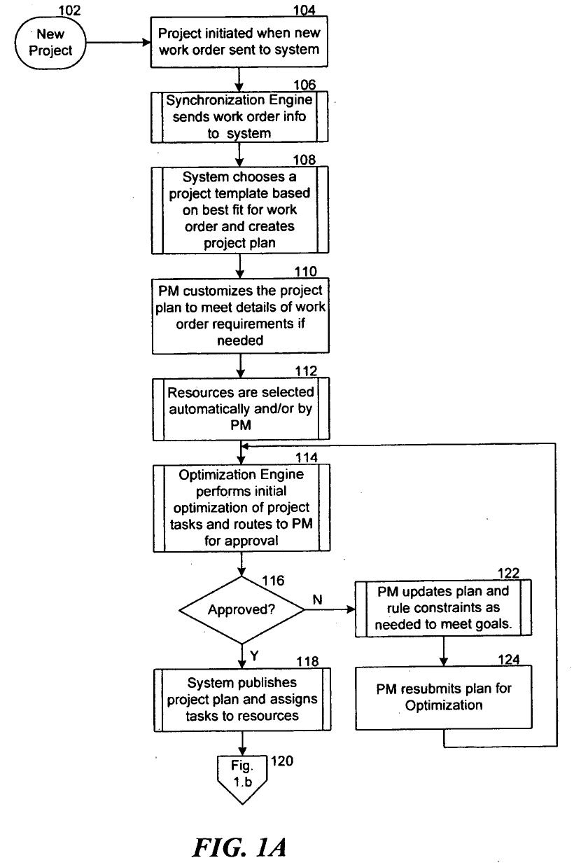

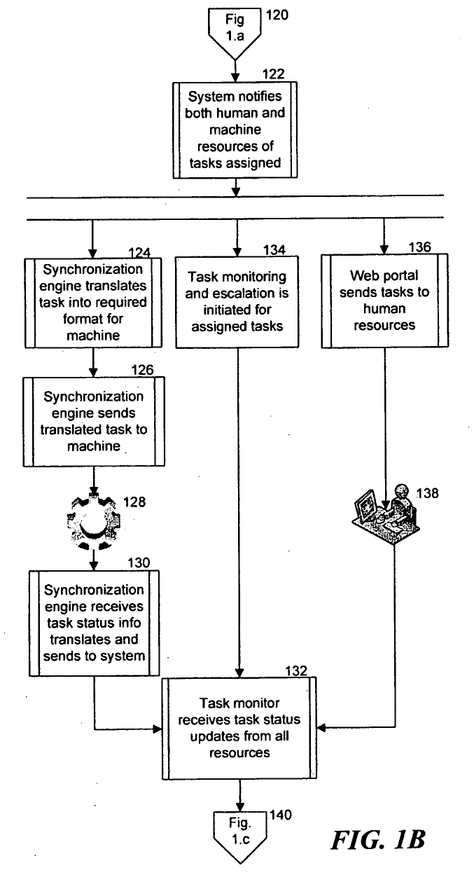

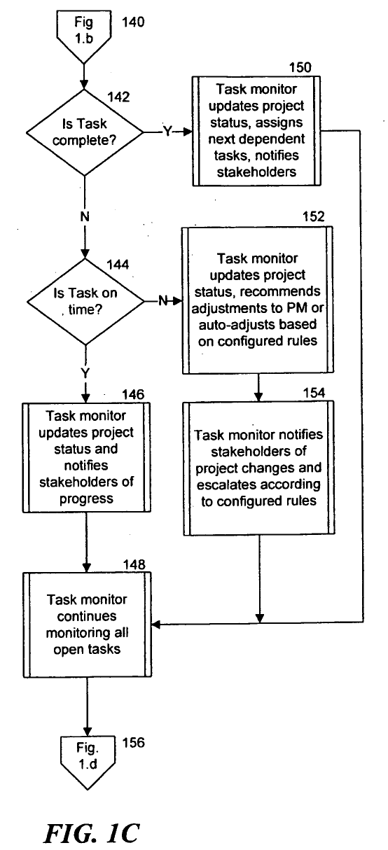

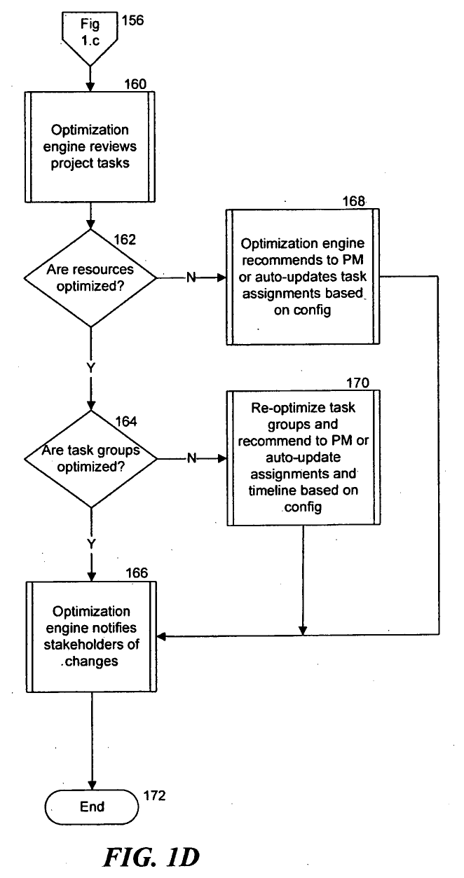

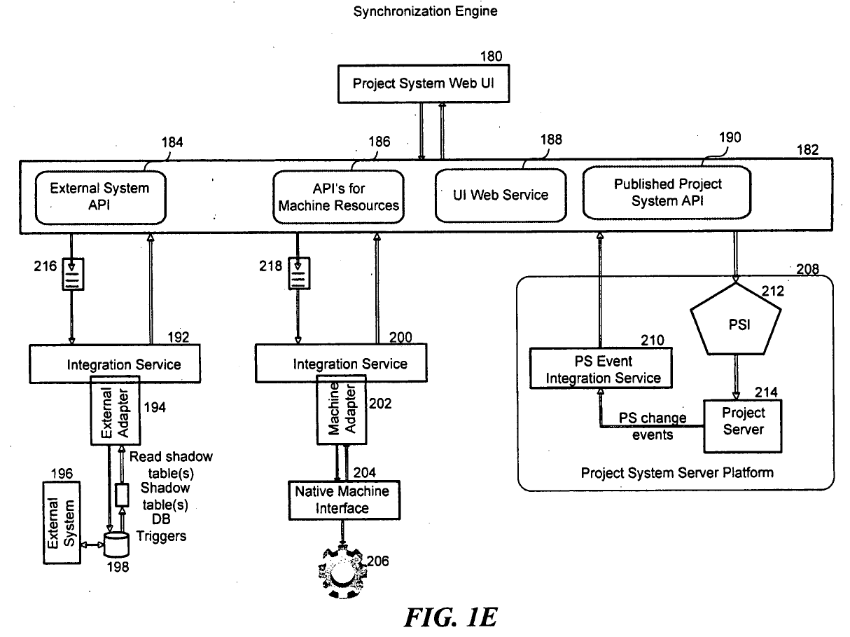

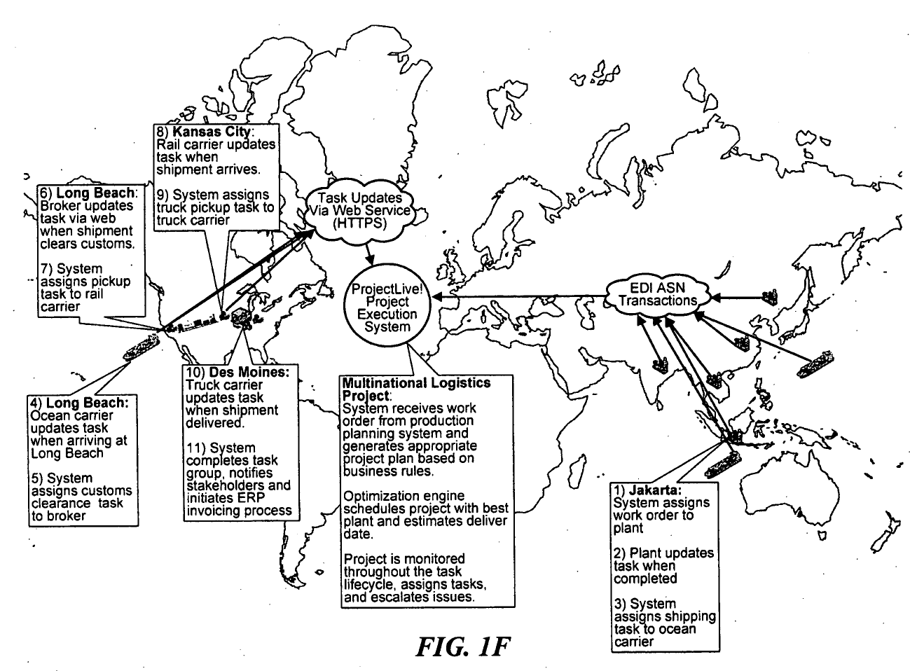

FIGS. 1A-1F are flow diagrams illustrating flows within the system in various embodiments.

In FIG. 1A, a user creates a new project 102. The system initiates a new project when it receives a new work order 104. At block 106, a synchronization engine sends work order information to the system. As an example, the work order information can include information about the project. At block 108, the system selects a project template that is best suited for the work order and creates a project plan. At block 110 a PM optionally customizes the project plan, such as based on the work order requirements. At block 112, the system assigns available resources to each task of the project. Alternatively, the PM may assign tasks to the tasks. At block 114, an optimization engine performs initial optimization of project tasks and sends the optimized project plan to the PM for approval. At decision block 116, the PM can either approve or disapprove the project plan. If the PM approves it, the system publishes the project plan and assigns tasks to the resources, such as by notifying each resource of the new project. The system then continues at block 120. If the PM disapproves the project plan, the system continues at block 122 where the PM updates the project plan and rule constraints to meet the project's goals and at block 124 the PM re-submits the plan for optimization. The system then continues at block 114.

In various embodiments, the system can automate the process of reviewing and assigning tasks to resources by monitoring and assigning tasks to both human and machine resources based on an intelligent workflow engine that tracks completion of prerequisite tasks and resource utilization. This system-directed, real time assignment and updates of tasks can remove “dead time” between task execution and can ensure full utilization of resources.

In FIG. 1B, the system continues at block 120 from FIG. 1A. At block 122, the system notifies human and machine resources of their assigned tasks. At block 124, the synchronization engine translates tasks into a format suitable for the assigned machine resource. As an example, the synchronization engine may employ machine instructions stored in an education component associated with the project task. At block 126, the synchronization engine sends the translated task to the machine. At block 128, the machine completes the assigned task. At block 130, the synchronization engine receives task status information, translates the information, and sends the translated information to the system. At block 132, a task monitor receives task status updates from all resources and the system then continues at block 140. At block 134, a task monitoring and escalation tool is initiated for the assigned tasks. The tool can invoke workflow steps when a task is started, completed, delayed, or worked on. At block 136, a Web portal sends tasks to human resources. A human resource 138 can then complete the task. After completion at block 138 or monitoring/escalation at 134, the system continues at block 132.

The system can include a rule engine that tracks the progress of task completion to the plan. The rule engine can generate exceptions and notify stakeholders (e.g., customers, project managers, etc.) when configured exceptions occur. In addition, an automated escalation process can be configured to ensure that unhandled exceptions are escalated to senior managers and other stakeholders according to established project policies. The system will recognize task delays and automatically send communications to the project manger regarding the impact on all dependencies already built into the project plan due to the delay of the first task. The project manager will have the option to extend a delay to each subsequent task, continue to proceed on each subsequent task without completion of the original task, or add/delete tasks based on the direction of the project manager.

In FIG. 1C, the system continues at block 140 from FIG. 1B. At decision block 142, the system determines whether the task is complete. If the task is incomplete, the system continues at decision block 144. If the task is complete, the system continues at block 150. The system may determine that a task is complete when the resource assigned to the task indicates that the task is complete. Alternatively, the system may automatically determine that a task is complete. At decision block 144, the system determines whether the task is on time. If the task is on time, the system continues at block 146. Otherwise, the system continues at block 152. At block 146, the task monitor updates the project status and notifies stakeholders of the progress. As an example, the task monitor may initiate a workflow step to notify stakeholders via e-mail. The system then continues at block 148. At block 148, the task monitor continues monitoring all the tasks that remain to be completed. At block 150, the task monitor updates to project status and assigns a next dependent task. The next dependent task may be assigned to the same resource that completed the task or a different resource. The task monitor may also notify stakeholders. As an example, the task monitor may initiate a workflow step to notify stakeholders. At block 152, the task monitor updates the project status, and may recommend adjustments to the PM or may automatically adjust the project schedule based on configured rules. The system then continues at block 154, where the task monitor notifies stakeholders of project changes and may escalate the issue according to configured workflow rules. The system then continues at block 156.

In FIG. 1D, the system continues at block 156 from FIG. 1C. At block 160, and optimization engine reviews the project tasks. At decision block 162, the optimization engine determines whether the resources are optimized. If the resources are optimized, the system continues at decision block 164. Otherwise, the system continues at block 168. At decision block 164, the system determines whether task groups are optimized. A task group is a collection of tasks. If the task groups are optimized, the system continues at block 166. Otherwise, the system continues at block 170. At block 166, the optimization engine notifies stakeholders of any changes that were made to the project schedule. The system then returns at block 172. At block 168, the optimization engine recommends to the PM to change task assignments or may automatically make changes to task assignments based on configured rules. The system then continues at block 166. At block 170, the system may re-optimize task groups and make recommendations to the PM or may automatically adjust the groups and timeline based on configured rules. The system then continues at block 166.

The system can include an optimization engine that re-plans and optimizes task sequence and assignment based on feedback from resource task updates and project plan changes. This engine may utilize a variety of algorithms known in the project planning industry or proprietary processes to determine how the project plan should be adjusted for optimal utilization of resources and time. This engine can be configured to run continually, on a scheduled basis or on demand. The optimization engine can be configured to automatically adjust the project plan and task assignments or to notify and recommend changes for approval by a project manager or other stakeholder. The use of mathematical optimization has applied to a variety of common industry problems. For example, automobile manufacturers can encounter the Process Scheduling Problem. A number of tasks are identified that each must be performed in a manufacturing plant. Some of the tasks depend on the completion of others, while others are independent. To optimize the entire process mathematically, tasks are divided into groups that can be carried out simultaneously with all other task groups. Then the times taken to perform the individual tasks in each group are added to determine the time it takes to complete that group and then the maximum of those times is identified. The longest time is how long it takes to complete all the tasks using that particular grouping. Comparing the total time of all possible groupings enables the system to choose the optimal groupings and sequence of tasks to complete the manufacturing process.

The system can initially optimize the groupings and order of tasks based on task dependencies, resource availability and time constraints. Then, as feedback is collected from human and machine resources including task completion, time slippage, resource changes, scope changes and other input, the system can re-optimize the project and either recommend schedule/resource/task changes or automatically make changes based on configuration settings. The optimization can employ various algorithms including, e.g., combinatorial methods, derivative-free methods, first order methods, second-order methods, lagrange multipliers, or proprietary methods.

FIG. 1E illustrates aspects of the synchronization engine. The system may include a project system Web user interface (“UI”) 180. The Web UI may interact with various components 182, such as an external system API 184, machine resource API 186, Web service UI 188, and published project system API 190. The external system API 184 may provide parameters or other information 216 to an integration service 192 that, via an external adapter 194 can command an external system 196. Various database components 198, such as triggers and tables, can enable interaction between the external system 196 and integration service 192. Examples of external systems include ERP and MPR systems. The machine resource API 186 may provide parameters or other information 218 to an integration service 200 that, via an external adapter 202, can command a native machine interface 204 to control a machine 206, such as to complete a task. The published project system API 10 can interact with a Project Server Interface 212 to control a Project Server 214. When the project changes, it sends change events that the published project system API can receive via the Project Server Event Integration Service 210. Components 212, 214, and 210 can be a part of a Project System Server Platform 208.

FIG. 1F is a map providing an example of how the system may be fully integrated with other enterprise systems. The system can interact with all resources and other systems through the electronic application interface and can receive real-time feedback from resources. When this occurs, the system can dynamically adjust the project plan (e.g., project schedule). This real time interaction ensures that project plans are always up to date and that project exceptions can be handled as soon as they occur, thereby minimizing project slippage and cost overruns. Using the integration engine, the system may be extended beyond traditional project management systems by integrating it with other enterprise systems such as a shipping system, a production planning system and electronic data interchange (“EDI”) communications to create a complete logistics planning project execution system that a multinational organization can employ. In the illustrated example, the system is connected to plants and warehouses worldwide and treats them as a series enterprise wide logistics project. The multinational organization has five plants across Asia each with its own warehouse for outbound shipping, an ocean freight forwarder, a dock in Long Beach, a container cartage truck line to take a container to a railhead, railroad to take the goods to a rail terminal in Kansas City, and a truck freight company to take the shipment to its final destination in Des Moines. The system can track all manufacturing and product movement activity as tasks in a project plan. Each task can be set up with configured settings or manual settings to manage the movement of those products throughout the supply chain. All output of production and freight movement can be communicated to the system via the EDI system or other method and the system can recognize those communications as updates to the project plan and can recommend or make automated changes accordingly. Using this system, any multinational company could have real time knowledge of their production and supply chain worldwide without making a single phone call.

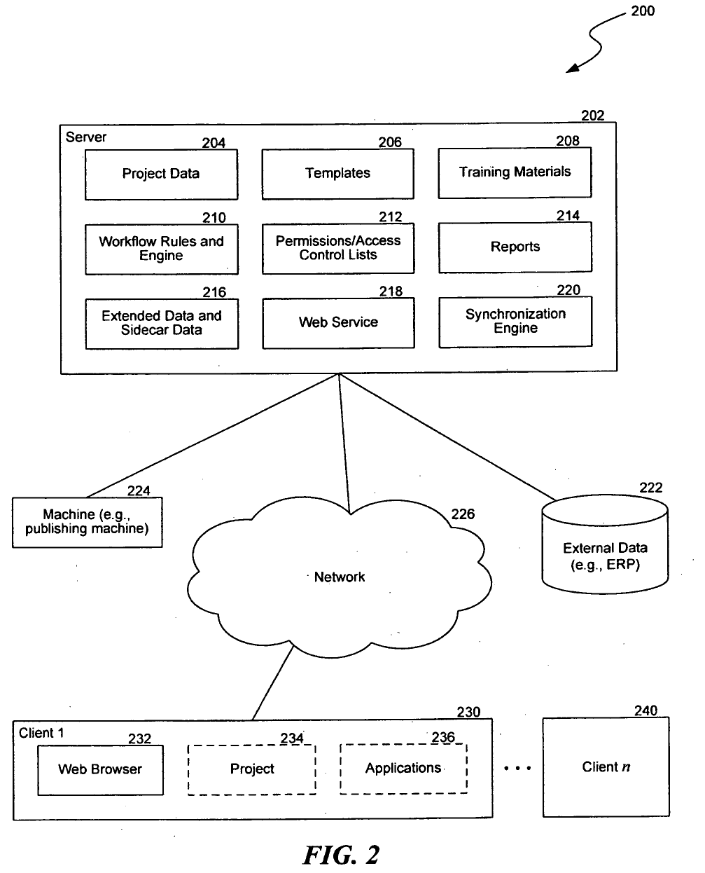

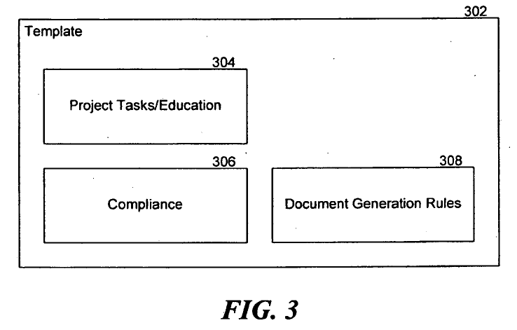

FIGS. 2-3 are block diagrams illustrating components of the system in various embodiments.

The system 200 can include a server 202 and one or more clients, such as clients 230 and 240. The server 202 can include various components. A project data component 204 stores project plan information, such as tasks. It can be created from a template 206. A template is described in further detail below in relation to FIG. 3. The system can include education components, such as training materials 208. The training materials can be in various forms, such as in Web pages, documents, audiovisual clips, and so forth. A workflow engine and/or rules 210 can implement various workflow processes associated with the system, including, e.g., communicating status, assigning tasks, and so forth. A permissions component 212 can enforce access permissions on various parts of the system. As an example, a resource may only be able to view and/or update tasks assigned to that resource. A reports component 214 can generate various reports, such as status reports, automatically. An extended data component 216 (“sidecar component”) can store extended (“sidecar”) data. The extended/sidecar data is additional data corresponding to each task, such as pointers to training materials or other that a synchronization engine 220 synchronizes with an external data source 222, such as ERP or MRP database. The system can also provide a Web service 218, so that a Web browser 232 operating at a client 230 or other application 236 can interface with the server 202 to make updates, retrieve data, and so forth. The system can also command various machines 224, such as to assign tasks to the machine and schedule jobs on the machine.

The server 202 may exchange data with clients (e.g., client 230) via a network 226, such as an intranet or the Internet. The client 230 can include a Web browser 232, project tool 234, applications 236, and other components.

Turning now to FIG. 3, a template 302 can include listings of project tasks and corresponding education components 304, compliance information 306, and document generation rules 308. The compliance information identifies how the system (or others) can determine whether a task is complete, on time, and so forth. The document generation rules identify how a document is to be created for each task. The template can include tasks and associated information that follows a best practices methodology for various project types.

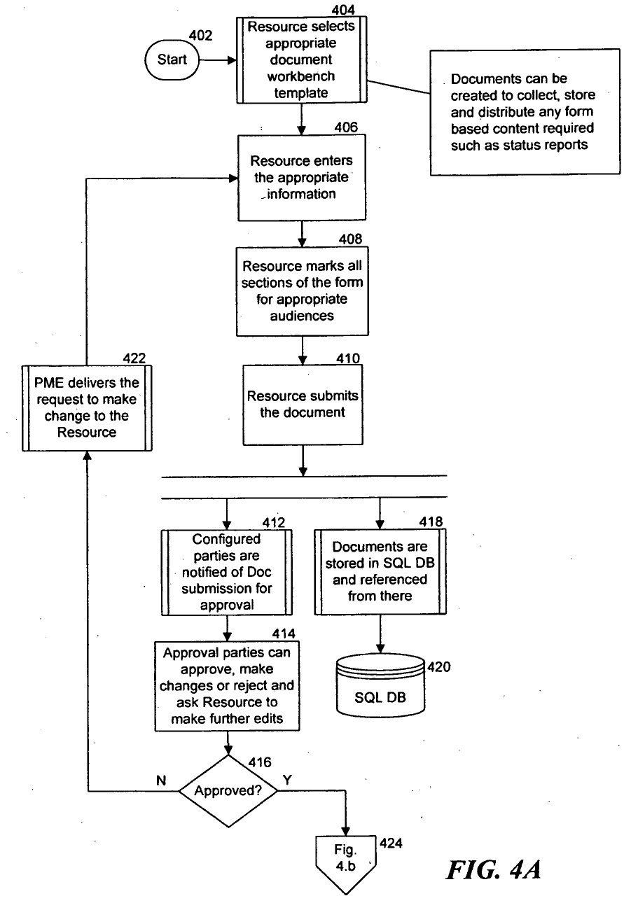

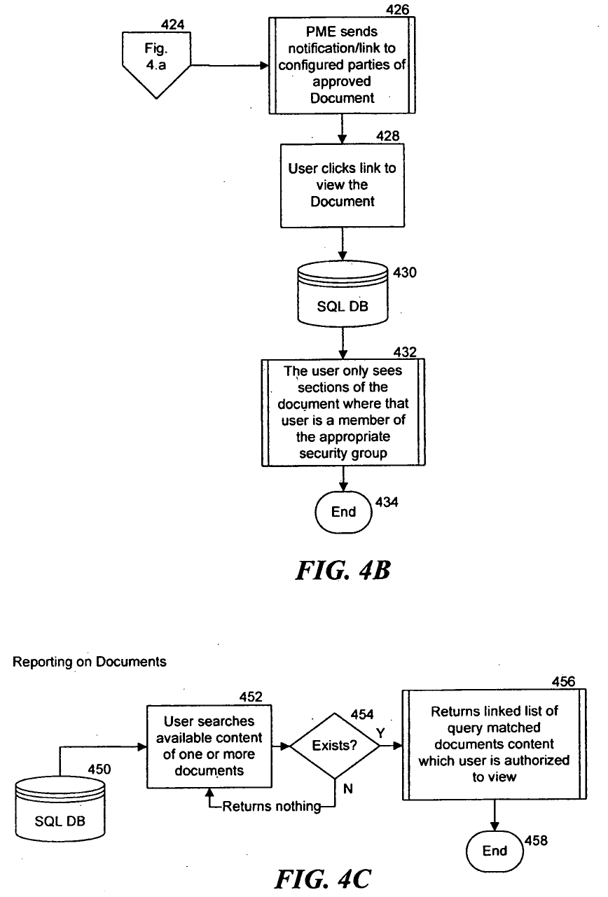

FIG. 4A is a flow diagram illustrating an embodiment of a consultant using the system's integrated document workbench to generate a deliverable document required for the project task assigned. The flow begins at block 402. At block 404, a resource (e.g., a user) selects an appropriate document workbench template. Documents can be created to collect, store, and distribute form-based content, such as status reports, expense reports, and so forth. A document workbench is a tool a user can use to create documents from templates. A template defines portions of the documents, such as form fields, and text that is common to all documents of a specified type. At block 406, the resource enters appropriate information, such as into form fields. At block 408, the resource indicates various permissions levels for sections of the form or document. As an example, some portions of an expense report may only be visible to the user's manager and not the customer. At block 410, the resource submits the document to the system. At block 412, the system notifies various parties that the document was created and may request their approval. The system may check workflow rules or other configuration settings to determine who to notify. At block 414, users who are indicated as the approving authority for the document can approve the document, make changes to it, rejected, ask the user to make changes to it, and so forth. At decision block 416, the system determines whether the document has been approved. If it has, the system continues at block 424. Otherwise, the system continues at block 422. At block 422, the system notifies the resource who submitted the documents so that the resource can revise the document, as required. At block 418, documents resources submit at block 410 are stored in a database, such as a SQL database 420.

FIG. 4B is a flow diagram illustrating an embodiment of an electronic workflow showing approval and electronic delivery of the document generated in 4A. The system continues at block 424 from FIG. 4A. At block 426, the system sends a notification that may contain a link to the submitted document to various users, such as users that are configured to receive the document. At block 428, a receiving user can select the link to view the document. The system may then retrieve the document from a database, such as a SQL database 430. At block 432, the system displays to the user only those portions of the document to which the user has been provided access. The access permissions may be determined by settings indicated by the resource that created the document as well as other system configuration settings.

FIG. 4C is a flow diagram illustrating document reporting. At block 452, a user searches for available content in one or more documents. The system retrieves documents and their contents from a database, such as a SQL database 450. At decision block 454, the system determines whether a document satisfies provided search criteria. If there are one or more such documents, the system continues at block 456. Otherwise, the system continues at block 452. At block 456, the system returns a list of documents that matches the specified criteria and which are accessible by the user. The system then returns a block 458. The user can select one or more of the links to view the documents.

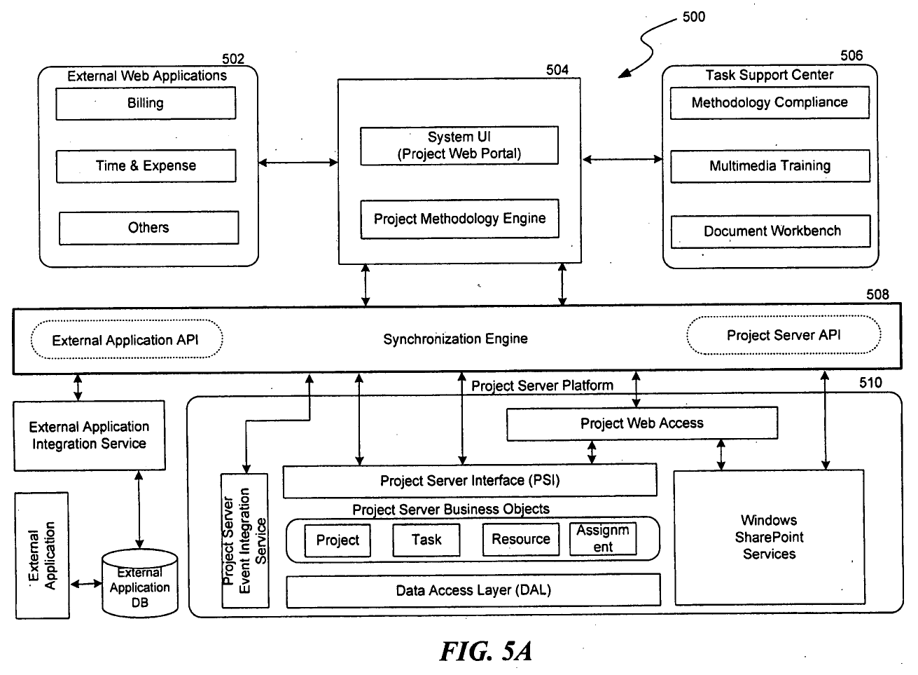

FIG. 5A is a block diagram illustrating an embodiment of the system integrated with a project management system and other systems. The system 500 includes system components 504, a task support center 506, and a synchronization engine 508. The system may also interact with external web applications 502. The system components 504 include user-interface and project methodology engine components. The task support center 506 includes components that check methodology compliance, provide multimedia training, and provide tools to create documents, such as the document workbench. The synchronization engine 508 may use various application program interfaces (“APIs”) to communicate with external systems, such as external applications and project management tools.

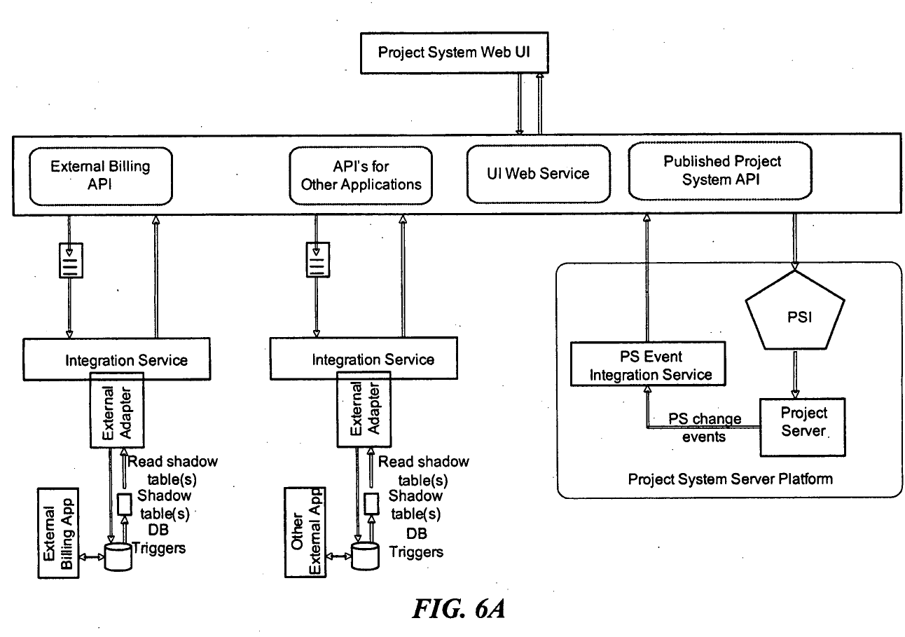

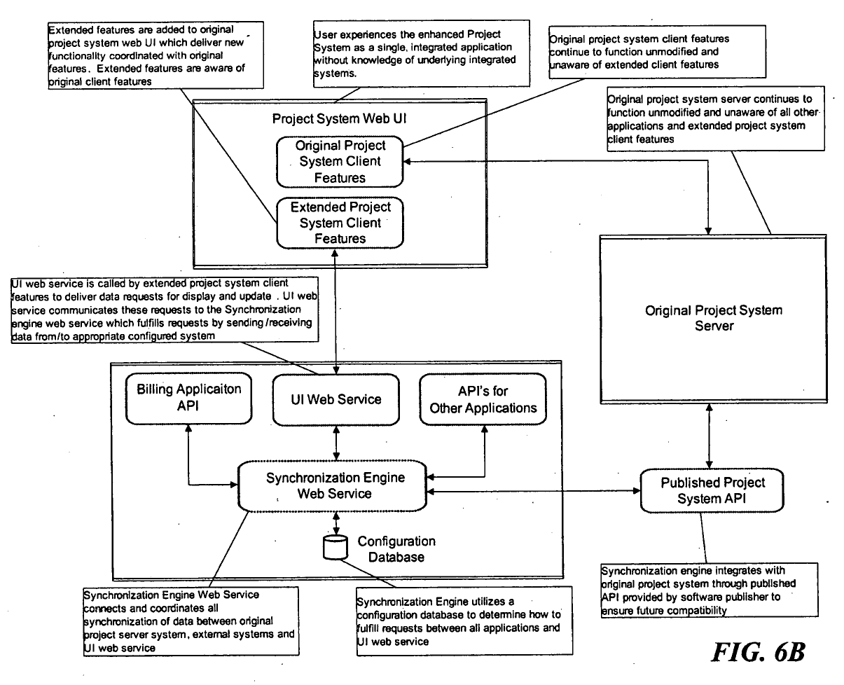

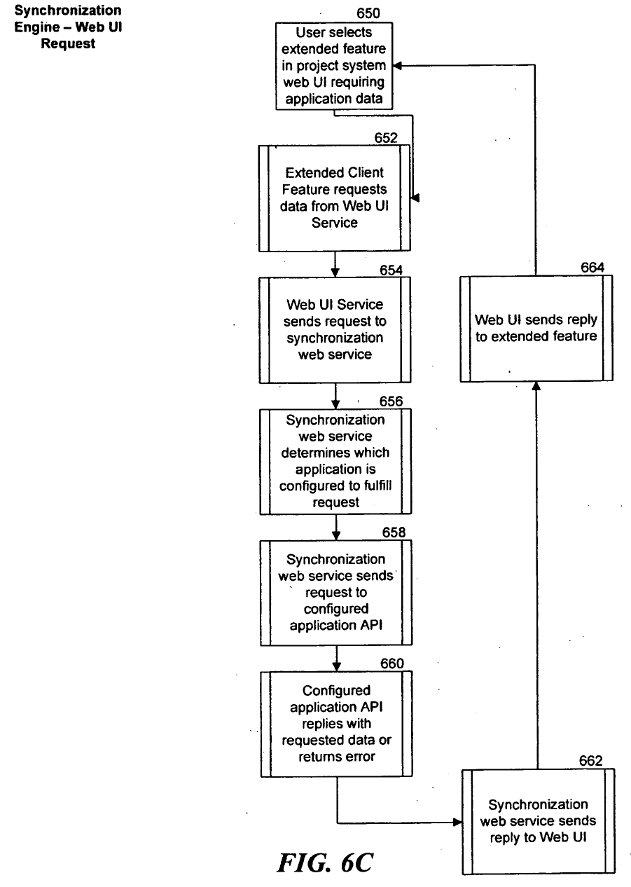

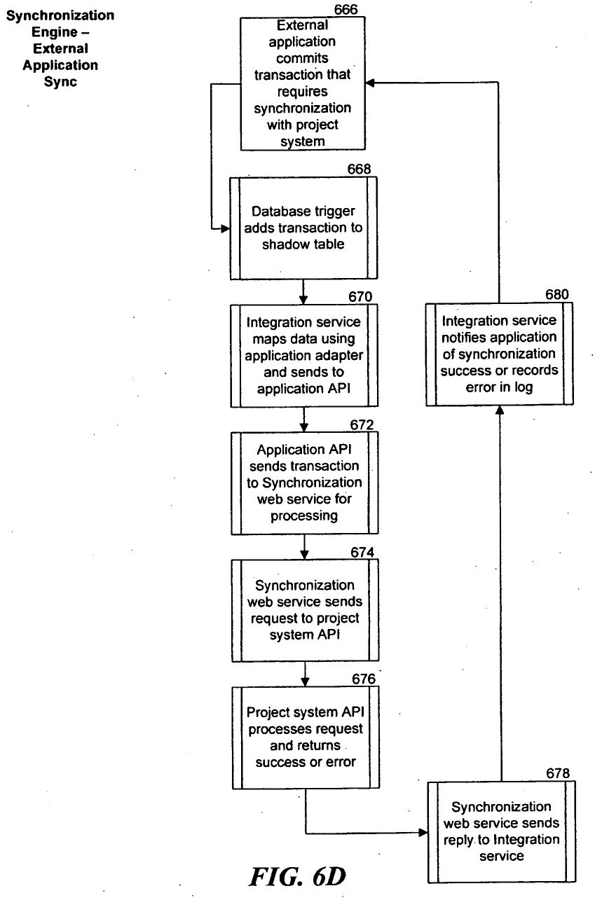

FIGS. 6A-6B are block diagrams illustrating an embodiment of the architecture of the system's synchronization engine.

FIGS. 6C-6D are flow diagrams illustrating an embodiment of the synchronization of transactions between the project server and applications integrated with the system's Synchronization Engine.

FIG. 6C illustrates providing data requested via a Web user interface. At block 650, a user selects an extended feature in a project system web user-interface that requires application data. At block 652, the extended feature requests data from a Web user interface (“UI”) service provided by the system. At block 654, the Web UI service is sends a request to a synchronization service. At block 656, the synchronization service determines which application is to fulfill the request. At block 658, the synchronization service sends the request to the selected application, such as via an API that is provided by the selected application. At block 660, the application responds with the requested data or returns an error. At block 662, the synchronization service sends a reply to the Web UI. At block 664, the Web UI sends a reply to the extended feature.

FIG. 6D illustrates providing data requested via an external application. At block 666, an external application commits a transaction. At block 668, a database trigger ads a transaction to a shadow table. At block 670, and integration service maps data using an application adapter and sends data to an application API. At block 672, the application API sends the transaction to the synchronization service for processing. At block 674, the synchronization service sends a request containing data to a project system API. At block 676, the project system API processes the request and returns success or error. At block 678, the synchronization service sends a reply to an integration service. At block 680, the integration service notifies the application of synchronization success or records an error in a log.

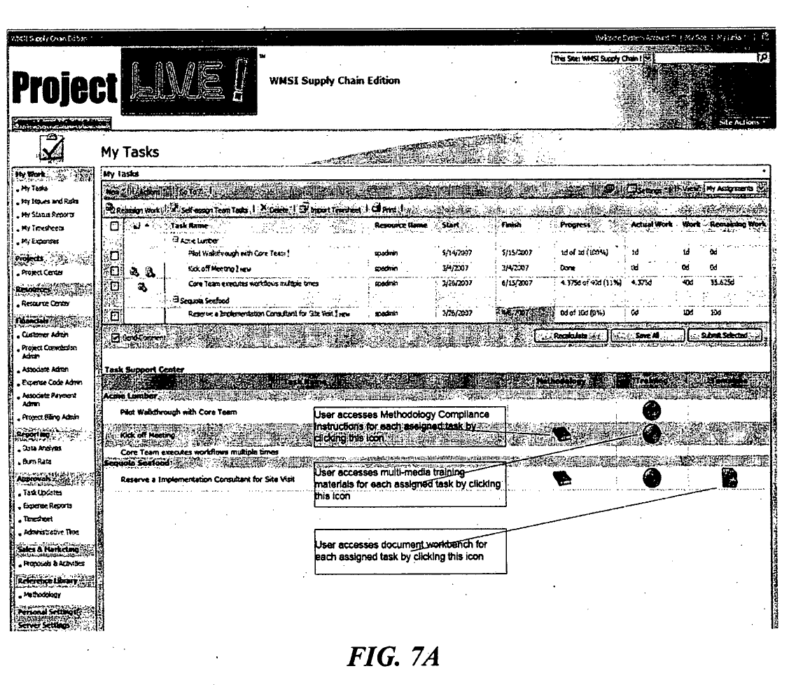

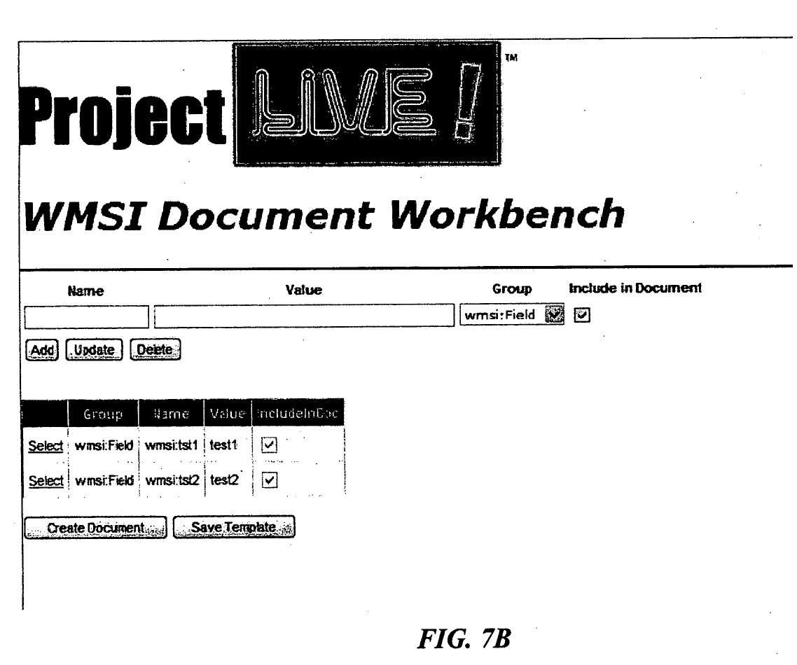

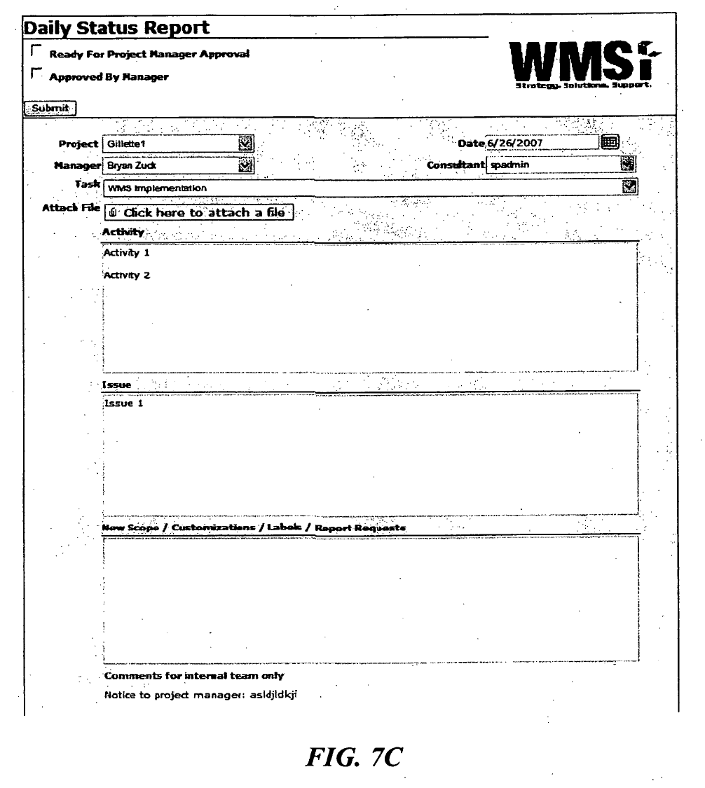

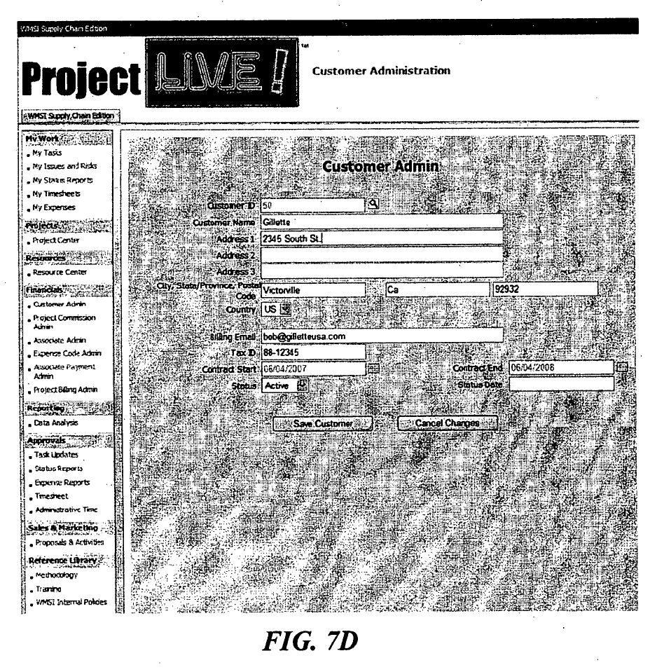

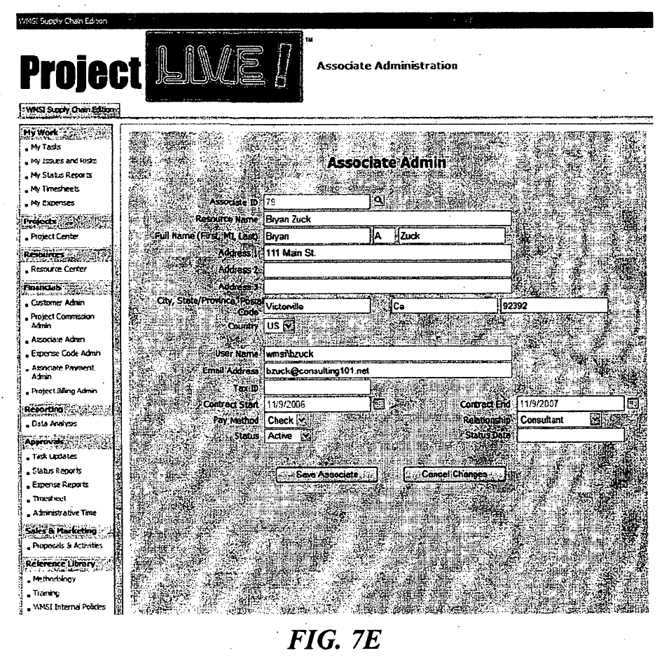

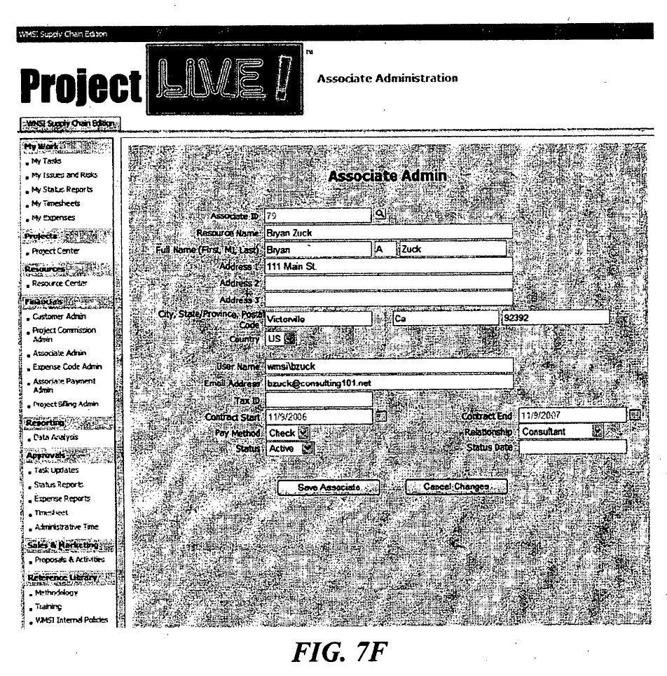

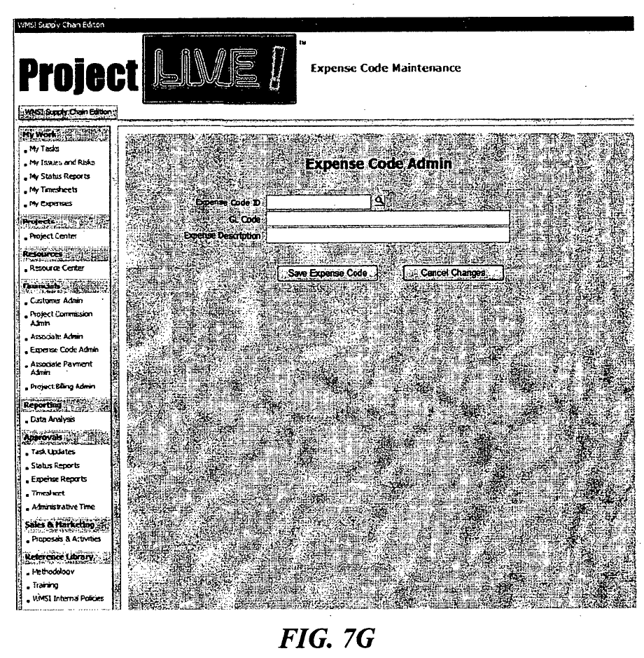

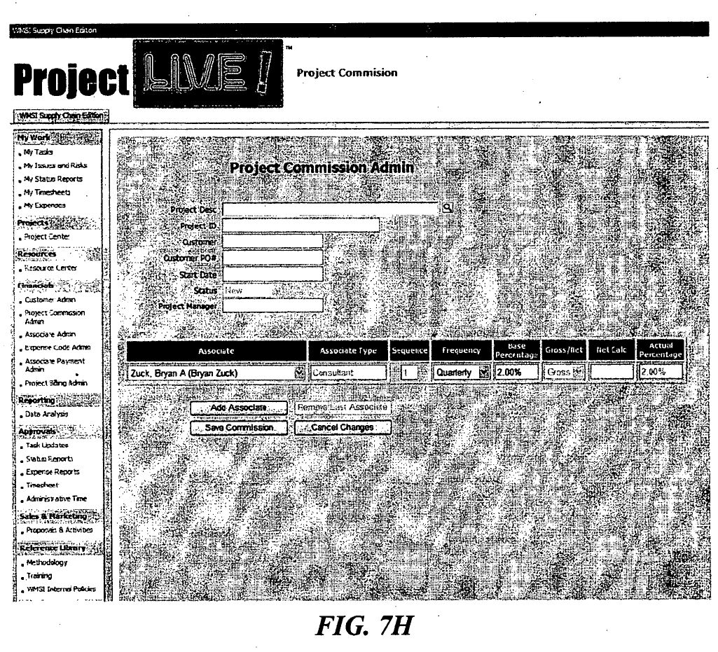

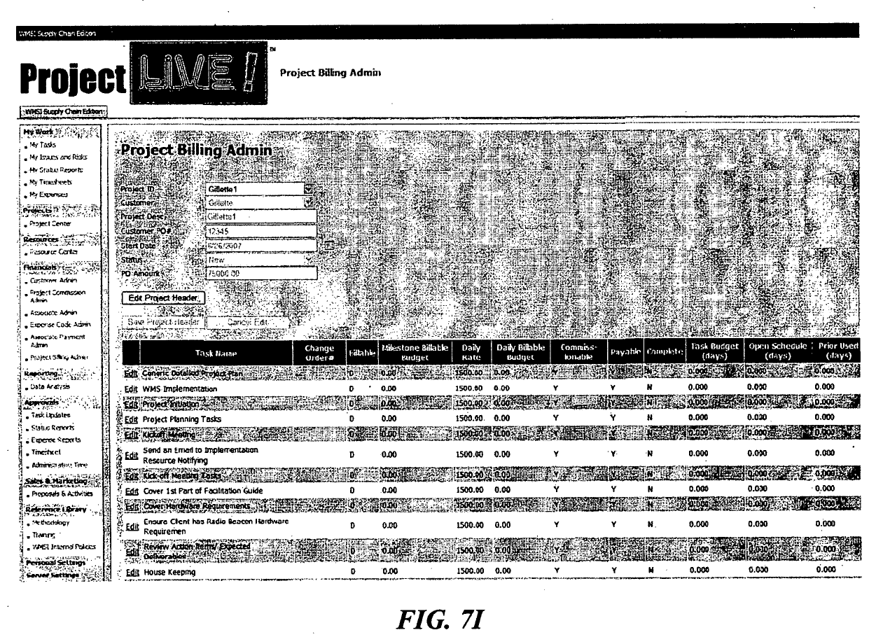

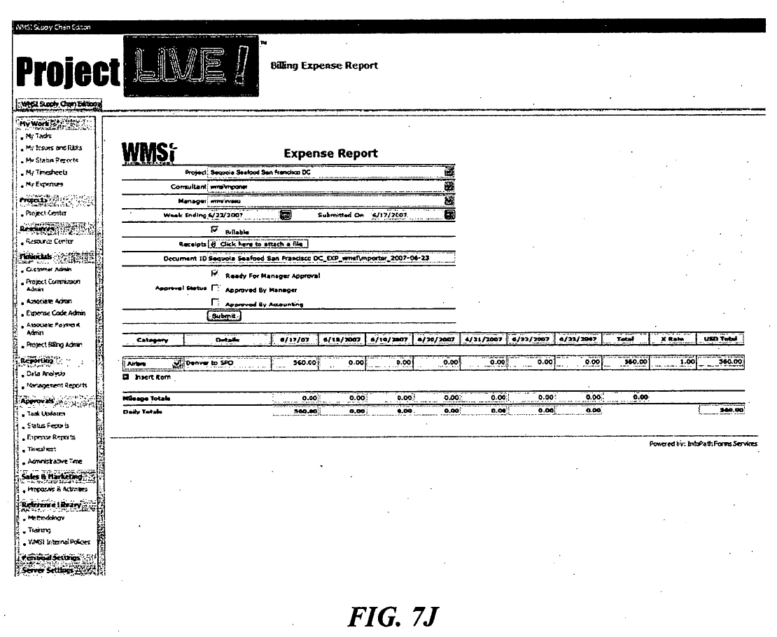

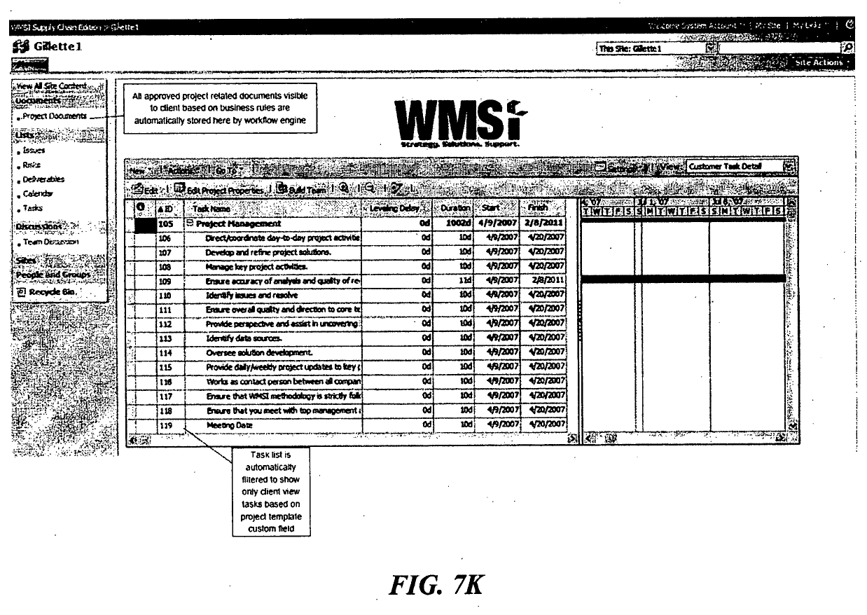

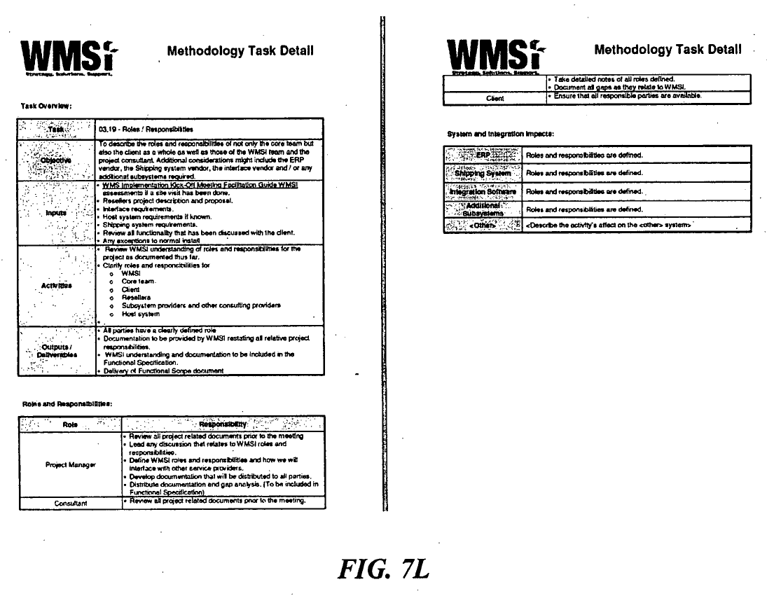

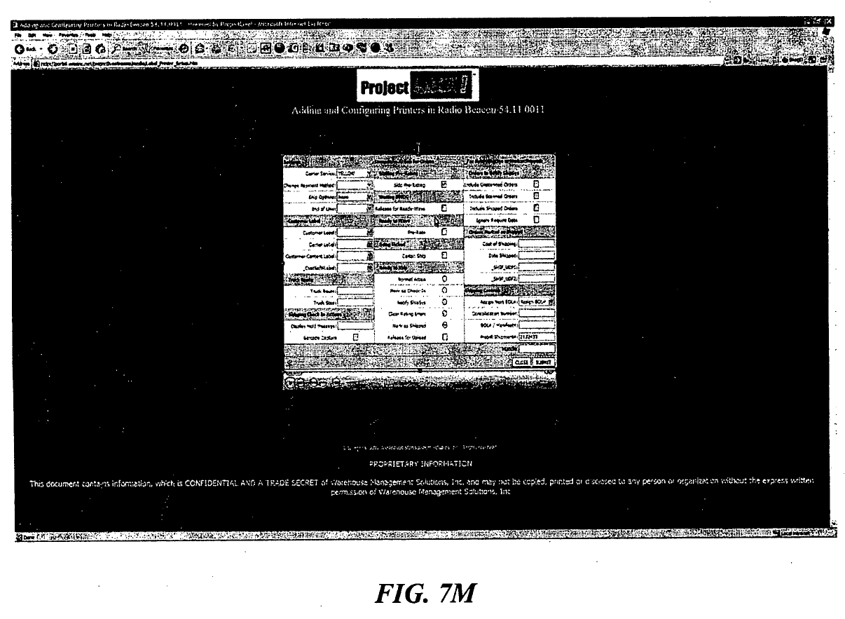

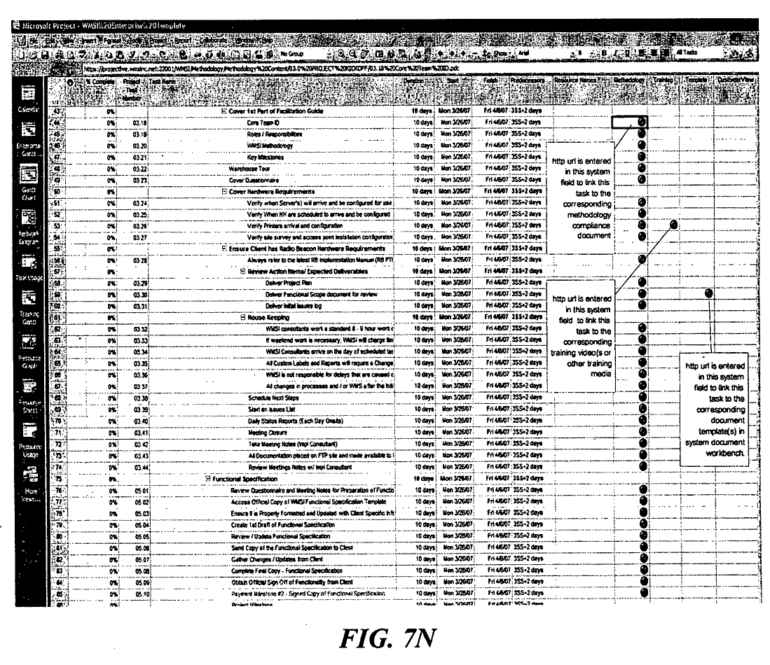

FIG. 7A is a diagram illustrating an embodiment of the graphical user interface of the system showing the screen display where users access the features described above.

FIG. 7B is a diagram illustrating an embodiment of the graphical user interface of the system showing the screen display where users access the features described in FIG. 4A.

FIG. 7C is a diagram illustrating an embodiment of the graphical user interface of the system showing the screen display where users create daily status reports for active projects.

FIGS. 7D-7J are diagrams illustrating an embodiment of the graphical user interfaces of the system showing the screen display that comprise the systems integrated billing features.

FIG. 7K is a diagram illustrating an embodiment of the graphical user interface of the system showing the screen display of the integrated end user portal which is used to electronically deliver all project related documents and project information that the end user sees.

FIG. 7L is a diagram illustrating an embodiment of the graphical user interface of the system showing the screen display of a sample methodology compliance instructions for a specific task. This screen can be accessed by accessing the associated button show in FIG. 7B.

FIG. 7M is a diagram illustrating an embodiment of the graphical user interface of the system showing the screen display of a sample training video for a specific task. This screen can be accessed by accessing the associated button show in FIG. 7B.

FIG. 7N is a diagram illustrating an embodiment of the graphical user interface of the system showing the screen display of a sample project template. This screen can be accessed through Microsoft Project 2007.

The system thus frees project managers from the mundane work of updating project plans, collecting progress information and reformatting information into status reports. Project plans can be collaboratively built and maintained by the project team, often by reusing learning, deliverables and templates from previous projects.

The system can automatically assign tasks to machines and software programs resources. The system can fully integrate with electronic equipment so that the system can schedule a machine, assign tasks to it, and track progress of task completion. The synchronization engine can support the integration of a wide variety of machines, including, e.g., printing presses, manufacturing equipment, EDI documents and other automated processes driven by a computer. Bridging the gap between human and machine resources will allow comprehensive planning and tracking throughout the project lifecycle for all project resources. Machines are able to report task completion and status information to the system as well. For example, printing presses may be assigned printing tasks along with specific machine instructions for completing the task. Status information can be reported through the interface to keep the system up to date and support scheduling of machine resources.

Those skilled in the art will appreciate that the logic illustrated in the figures and described above may be altered in a variety of ways. For example, the order of the logic may be rearranged, substeps may be performed in parallel, illustrated logic may be omitted, other logic may be included, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing system for integrating a methodology management system with a project management system, comprising:
generating a project plan based on a project template wherein the project template includes a project task, an education component corresponding to the project task, a compliance factor, and a document creation rule;
causing the education component to be provided;
receiving an indication that the project task was completed;
determining whether the compliance factor has been satisfied; and
generating a document based on the document creation rule.

2. The method of claim 1 wherein the project plan is stored as an XML file.

3. The method of claim 1 wherein the education component is provided as a multimedia file.

4. The method of claim 1 further comprising performing a workflow step corresponding to the project task.

5. The method of claim 4 wherein the workflow step includes requesting approval.

6. The method of claim 5 wherein a request is sent via an electronic messaging system.

7. The method of claim 1 wherein the document is a report that reports progress of the project plan.

8. The method of claim 1 wherein the document is an expense report.

9. A system for integrating a methodology management system with a project management system, comprising:
a central processing unit;
a project management template for use with a project management tool wherein the project management template includes a project task, an education component corresponding to the project task, a compliance factor, and a document creation rule;
a synchronization engine that synchronizes data of the project management tool with an external data source; and
a workflow engine that causes a workflow step to be performed based on a state of the project task.

10. The system of claim 9 wherein the workflow step is performed when the project task is started.

11. The system of claim 9 wherein the workflow step is performed when the project task is completed.

12. The system of claim 9 wherein the workflow step is performed when the project task is delayed.

13. The system of claim 9 further comprising a machine that is caused to perform work based on the project task.

14. The system of claim 9 wherein the external data source is a customer relationship management tool.

15. The system of claim 9 wherein the external data source is an enterprise resource planning tool.

16. The system of claim 9 wherein the external data source is a manufacturing resource planning tool.

17. The system of claim 9 further comprising extended data that extends data provided by the project management tool wherein the synchronization engine synchronizes data between the external data source and the extended data.

18. The system of claim 17 wherein the synchronization engine synchronizes resources available to be assigned to a project task.

19. A computer-readable medium storing computer-executable instructions that, when executed, cause a computing system to perform a method for integrating a methodology management system with a project management system, the method comprising:
receiving a project template wherein the project template includes a project task, an education component corresponding to the project task, a compliance factor, and a document creation rule;
receiving a command to create a project plan based on the project template;
generating the project plan based on the template wherein the project plan includes the project task;
receiving an indication of a resource to assign to the project task;
providing the education component to the indicated resource;
receiving a status update from the resource relating to the project task;
determining whether the status update satisfies the compliance factor; and
generating a document based on the document creation rule.

20. The computer-readable medium of claim 19 wherein the method further comprises performing a workflow step based on the status update.

21. The computer-readable medium of claim 19 wherein the resource is a machine and the method further comprises commanding the machine to complete the project task.

22. The computer-readable medium of claim 21 wherein the education component includes a sequence of steps the machine is to perform.

23. The computer-readable medium of claim 19 further comprising automatically revising the generated project plan based on a business rule if the project task is delayed.
